(19) United States
(12) Patent Application Publication
(10) Pub. No.: US 2025/0197233 A1
(43) Pub. Date: Jun. 19, 2025

(54) METHOD OF COLLECTING ANHYDROUS SODIUM SULFATE FROM FLY ASH

(71) Applicant: INDUSTRIAL TECHNOLOGY RESEARCH INSTITUTE, Hsinchu (TW)

(72) Inventors: Chien-Wen LIN, Taoyuan City (TW); Yi-Liang TSAI, Taichung City (TW); Chao-Wu LIAW, New Taipei City (TW); Woan-Shiow TSERNG, Hsinchu City (TW); Chih-Lung CHIN, Hsinchu City (TW); Shih-Hsien LIU, Jhubei City (TW)

(73) Assignee: INDUSTRIAL TECHNOLOGY RESEARCH INSTITUTE, Hsinchu (TW)

(21) Appl. No.: 18/543,041

(22) Filed: Dec. 18, 2023

(51) Int. Cl. C01D 5/16; C01D 5/18; C02F 1/56; C02F 101/20

(52) U.S. Cl. CPC C01D 5/16; C01D 5/18; C02F 1/56; C02F 2101/20

(57) ABSTRACT

A method of collecting anhydrous sodium sulfate from fly ash includes heating a purified sodium sulfate solution to 60° C. to 80° C., and adding a precipitation promoter to the purified sodium sulfate solution to precipitate anhydrous sodium sulfate crystal. The method further includes cooling the purified sodium sulfate solution and the anhydrous sodium sulfate crystal to 35° C. to 55° C. for precipitating more anhydrous sodium sulfate crystal, and collecting and drying the anhydrous sodium sulfate crystal.

### TECHNICAL FIELD

The technical field relates to collecting anhydrous sodium sulfate from fly ash.

### BACKGROUND

High-temperature refining industries such as steel, glass, and petrochemical often add a large amount of sodium sulfate to serve as a flux or defoaming agent. When the process temperature exceeds 1400° C., the sodium sulfate begins to boil and generates suspended particles with heavy metal ions such as chromium and cobalt. According to the law, the suspended particles such as fly ash byproducts must be collected through air pollution prevention equipment. Taiwan manufacturing industries produce more than 60,000 tons of various fly ash byproducts per year, thereby incurring billions of dollars in disposal expenses. Fly ash contains a large amount of sodium sulfate, inorganic salts, and metal ions. If the sodium sulfate can be recycled and purified, not only can the byproducts be decreased, but value can also be added to the finished product, carbon can be reduced, and other economic benefits can be enhanced.

### SUMMARY

One embodiment of the disclosure provides a method of collecting anhydrous sodium sulfate from fly ash, including: (i) evenly mixing water and fly ash, and removing liquid and keeping a solid; (ii) dissolving the solid with water at 40° C. to 70° C. to obtain a first solution, and adjusting the pH value of the first solution to 9 to 11; (iii) adding a heavy metal capture agent to the first solution to form a precipitate, and removing the precipitate to obtain a second solution; (iv) heating the second solution to 60° C. to 80° C., and adding a precipitation promoter to the second solution to precipitate anhydrous sodium sulfate crystal; (v) cooling the second solution and the anhydrous sodium sulfate crystal to 35° C. to 55° C. for precipitating more anhydrous sodium sulfate crystal; and (vi) collecting and drying the anhydrous sodium sulfate crystal.

In some embodiments, the water and the fly ash in step (i) have a weight ratio of 20:80 to 50:50.

In some embodiments, the water and the solid in step (ii) have a weight ratio of 50:50 to 80:20.

In some embodiments, the heavy metal capture agent in step (iii) includes ionic type polyacrylamide and iron sulfate.

In some embodiments, the temperature of heating the second solution in step (iv) is higher than the temperature of the water in step (ii).

In some embodiments, the precipitation promoter in step (iv) includes water soluble carbonate, sulfate, nitrate, or a combination thereof.

In some embodiments, the anhydrous sodium sulfate crystal collected in step (vi) and the precipitation promoter used in step (iv) have a weight ratio of 100:5 to 100:15.

In some embodiments, the fly ash in step (i) has a heavy metal content of >1000 ppm, and the anhydrous sodium sulfate crystal collected in step (vi) has a heavy metal content of less than 20 ppm.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a method of collecting anhydrous sodium sulfate from fly ash, including: (i) evenly mixing water and fly ash, and removing liquid and keeping a solid. In some embodiments, the fly ash may come from dyeing and finishing factories, glass factories, paper mills, or chemical plants, thereby containing a large amount of heavy metals and a low concentration of sodium sulfate. For example, the fly ash may contain >1000 ppm of the heavy metals as chromium, iron, cobalt, or the like, and less than or equal to about 40 wt % of sodium sulfate. In some embodiments, the water and the fly ash in step (i) have a weight ratio of 20:80 to 50:50. If water amount is too low, it may result in uneven mixing, difficult stirring reaction, and poor removal effect of heavy metals. If the water amount is too high, the final sodium sulfate yield will be too low. The water in step (i) may dissolve impurities of the fly ash to generate undissolved solid. The liquid can be removed by centrifugal, filtering, or the like to keep the solid.

Subsequently, the method then proceeds (ii) dissolving the solid with water at 40° C. to 70° C. to obtain a first solution, and adjusting the pH value of the first solution to 9 to 11. If the water temperature in this step is too low, the overly low dissolved amount of the sodium sulfate will influence the yield. If the water temperature is too high, too many impurities will be dissolved to influence the purity of the sodium sulfate product. In some embodiments, the water and the solid in step (ii) have a weight ratio of 50:50 to 80:20. If the water amount is too low, it may results in difficult stirring reaction, poor removal effect of heavy metals, and the other shortcomings. If the water amount is too high, the product crystal yield will be too low and the filtrate will be too much. If the pH value of the first solution is too low, sodium hydroxide, potassium hydroxide, or another suitable alkaline can be added. If the pH value of the first solution is too high, sulfuric acid, dilute sulfuric acid, or another suitable acid can be added. If the pH value of the first solution is overly low, the heavy metals will be difficult to be precipitated, and the removal effect of the heavy metals will be poor. If the pH value of the first solution is overly high, the sodium sulfate crystal yield will be low.

Subsequently, the method then proceeds (iii) adding a heavy metal capture agent to the first solution to form a precipitate, and removing the precipitate to obtain a second solution. The heavy metal capture agent can be ionic type polyacrylamide and iron sulfate, or another heavy metal capture agent. The precipitate includes the heavy metal capture agent and the heavy metals (from the fly ash) captured by the heavy metal capture agent. In general, the fly ash and the heavy metal capture agent may have a weight ratio of 100:5 to 100:15. If the heavy metal capture agent amount is too low, too many heavy metals will be remained in the sodium sulfate product. If the heavy metal capture agent amount is too high, it cannot further capture the heavy metal but increase the cost. Note that the effect of capture the heavy metals by the heavy metal capture agent has limitation, it is impossible to completely remove the heavy metals. In other words, the second solution after removing the precipitate still contains the heavy metals.

The method then proceeds (iv) heating the second solution to 60° C. to 80° C., and adding a precipitation promoter to the second solution to precipitate anhydrous sodium sulfate crystal. If the temperature of heating the second solution is too low, the sodium sulfate product containing multiple crystal water will be easily obtained. If the temperature of heating the second solution is too high, the aqueous solution will boil to increase the pressure. In some embodiments, the temperature of heating the second solution in step (iv) is higher than the temperature of the water in step (ii). If the temperature of heating the second solution in step (iv) is lower than or equal to the temperature of the water in step (ii), the product containing multiple crystal water will be easily obtained, thereby degrading the removal effect of the heavy metal due to crystal water easily dissolving the heavy metal.

In some embodiments, the precipitation promoter in step (iv) includes water soluble carbonate, sulfate, nitrate, or a combination thereof. For example, the carbonate, sulfate, nitrate, or a combination thereof of IA metal or IIA metal may serve as the precipitation promoter, as long as it is soluble in water. Note that when the sodium sulfate product is applied in glass factories, its halogen content should be extremely low. As such, sodium chloride is improper to serve as the precipitation promoter.

In some embodiments, the anhydrous sodium sulfate crystal collected in step (vi) and the precipitation promoter used in step (iv) have a weight ratio of 100:5 to 100:15. If the precipitation promoter amount is too low, the precipitation promoter cannot effectively precipitate the anhydrous sodium sulfate crystal in step (iv). If the precipitation promoter amount is too high, the effect cannot be further improved but the process cost will be increased.

The method then proceeds (iv) cooling the second solution and the anhydrous sodium sulfate crystal to 35° C. to 55° C. for precipitating more anhydrous sodium sulfate crystal. Because the anhydrous sodium sulfate crystal is precipitated in step (iv), the sodium sulfate crystal precipitated in the cooling step tends to be anhydrous (without crystal water). As such, the anhydrous sodium sulfate crystal obtained by this process can be free of the crystal water dissolving the heavy metals, thereby lowering the heavy metal content in the sodium sulfate product and increasing the purification effect.

The method then proceeds (v) collecting and drying the anhydrous sodium sulfate crystal. It should be understood that the water removed by this step is the water remained on the crystal surface rather than the so-called crystal water. Compared to the crystal water, the water on the crystal surface can be easily removed to greatly decrease the time for drying the product. In some embodiments, the drying step can be performed by heating, vacuum, or a combination thereof. In addition, the collected anhydrous sodium sulfate crystal (before being dried) can be directly measured by thermogravimetric analysis (TGA), which determines that the anhydrous sodium sulfate crystal before drying is free of the crystal water.

In some embodiments, the fly ash in step (i) has a heavy metal content of >1000 ppm, and the anhydrous sodium sulfate crystal collected in step (vi) has a heavy metal content of less than 20 ppm. In addition, the anhydrous sodium sulfate crystal collected in step (vi) may have a purity of higher than 90%.

There are two major conventional methods for producing sodium sulfate crystal: evaporating and removing the water in the sodium sulfate solution to precipitate sodium sulfate, or cooling the sodium sulfate solution to reduce the solubility of water to precipitate sodium sulfate. However, the sodium sulfate obtained from the above methods will contain the crystal water, and the crystal water is the major source of the heavy metals in the product. Even if the sodium sulfate crystal containing the crystal water is further dried to remove the water, the heavy metals dissolved in the crystal water are still remained in the sodium sulfate product. Compared to the conventional methods, the disclosed process may directly produce anhydrous sodium sulfate crystal (free of crystal water), thereby decreasing the heavy metals remained in the sodium sulfate product. On the other hand, the drying step of the disclosure does not need to remove the crystal water and therefore greatly decreasing the process time and cost (compared to the conventional methods those have to remove the crystal water to obtain the anhydrous sodium sulfate).

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

Fly ash A recycled from a glass factory had a sodium sulfate purity of 59% and a heavy metal concentration of 2737 ppm. 428 g of water and 1000 g of the fly ash A were mixed to generate a liquid dissolving the impurities of the fly ash A and an un-dissolved solid (about 850 g). After removing the liquid, the solid was dissolved with 1250 g of water at 50° C. to obtain a first solution. The pH value of the first solution was adjusted to 10. Heavy metal capture agents such as 63 g of ionic type polyacrylamide (commercially available from ACROS) and 21 g of iron sulfate were added to the first solution to generate a precipitate. The precipitate included the heavy metal capture agent and the heavy metals (from the fly ash A) captured by the heavy metal capture agent. The precipitate was then removed by filtering to obtain a second solution.

Subsequently, the second solution was heated to 70° C., and 120 g of precipitation promoter such as potassium sulfate was added to the second solution to precipitate anhydrous sodium sulfate crystal. Subsequently, the second solution and the anhydrous sodium sulfate were cooled to 40° C. to precipitate more anhydrous sodium sulfate crystal. The anhydrous sodium sulfate crystal was collected and dried, which had a purity of 91% and a heavy metal content of 16 ppm. The above process took about 12 hours.

### Comparative Example 1

428 g of water and 1000 g of the fly ash A were mixed to generate a liquid dissolving the impurities of the fly ash A and an un-dissolved solid (about 850 g). After removing the liquid, the solid was dissolved with 1250 g of water at 50° C. to obtain a first solution. The pH value of the first solution was adjusted to 10. Heavy metal capture agents such as 63 g of ionic type polyacrylamide (commercially available from ACROS) and 21 g of iron sulfate were added to the first solution to generate a precipitate. The precipitate included the heavy metal capture agent and the heavy metals (from the fly ash A) captured by the heavy metal capture agent. The precipitate was then removed by filtering to obtain a second solution. The above steps were similar to those in Example 1.

Subsequently, the second solution was cooled to 5° C. and kept at 5° C. for 16 hours for lowering the solubility of water to the sodium sulfate, thereby precipitating the sodium sulfate crystal (containing crystal water). The sodium sulfate crystal was then collected and dried at a high temperature of 120° C. for 3 hours to remove the crystal water in the sodium sulfate crystal. The dried sodium sulfate crystal had a purity of 88% and a heavy metal content of 26 ppm. The heavy metals mainly came from the crystal water. The above process took about 24 hours. Compared to Example 1, this process took more time to obtain the sodium sulfate with a lower purity and a higher heavy metal content.

### Comparative Example 2

428 g of water and 1000 g of the fly ash A were mixed to generate a liquid dissolving the impurities of the fly ash A and an un-dissolved solid (about 850 g). After removing the liquid, the solid was dissolved with 1250 g of water at 50° C. to obtain a first solution. The pH value of the first solution was adjusted to 10. Heavy metal capture agents such as 63 g of ionic type polyacrylamide (commercially available from ACROS) and 21 g of iron sulfate were added to the first solution to generate a precipitate. The precipitate included the heavy metal capture agent and the heavy metals (from the fly ash A) captured by the heavy metal capture agent. The precipitate was then removed by filtering to obtain a second solution. The above steps were similar to those in Example 1.

Subsequently, the second solution was heated to 90° C. and vacuumed to remove water for precipitating sodium sulfate crystal (containing crystal water). The second solution was then cooled to 20° C. and kept at 20° C. for 2 to 3 hours to precipitate sodium sulfate crystal (containing crystal water). The sodium sulfate crystal was then collected and dried at a high temperature of 120° C. for 3 hours to remove the crystal water in the sodium sulfate crystal. The dried sodium sulfate crystal had a purity of 84% and a heavy metal content of 39 ppm. The heavy metals mainly came from the crystal water. The above process took about 16 hours. Compared to Example 1, this process took more time to obtain the sodium sulfate with a lower purity and a higher heavy metal content.

### Example 2

Fly ash B recycled from a glass factory had a sodium sulfate purity of 61% and a heavy metal concentration of 1680 ppm. 420 g of water and 1000 g of the fly ash B were mixed to generate a liquid dissolving the impurities of the fly ash B and an un-dissolved solid (about 837 g). After removing the liquid, the solid was dissolved with 1250 g of water at 50° C. to obtain a first solution. The pH value of the first solution was adjusted to 10. Heavy metal capture agents such as 38 g of ionic type polyacrylamide (commercially available from ACROS) and 12 g of iron sulfate were added to the first solution to generate a precipitate. The precipitate included the heavy metal capture agent and the heavy metals (from the fly ash B) captured by the heavy metal capture agent. The precipitate was then removed by filtering to obtain a second solution.

Subsequently, the second solution was heated to 70° C., and 200 g of precipitation promoter such as potassium sulfate was added to the second solution to precipitate anhydrous sodium sulfate crystal. Subsequently, the second solution and the anhydrous sodium sulfate were cooled to 40° C. to precipitate more anhydrous sodium sulfate crystal. The anhydrous sodium sulfate crystal was collected and dried, which had a purity of 92% and a heavy metal content of 12 ppm. The above process took about 12 hours.

### Comparative Example 3

420 g of water and 1000 g of the fly ash B were mixed to generate a liquid dissolving the impurities of the fly ash B and an un-dissolved solid (about 837 g). After removing the liquid, the solid was dissolved with 1250 g of water at 50° C. to obtain a first solution. The pH value of the first solution was adjusted to 10. Heavy metal capture agents such as 38 g of ionic type polyacrylamide (commercially available from ACROS) and 12 g of iron sulfate were added to the first solution to generate a precipitate. The precipitate included the heavy metal capture agent and the heavy metals (from the fly ash B) captured by the heavy metal capture agent. The precipitate was then removed by filtering to obtain a second solution. The above steps were similar to those in Example 2.

Subsequently, the second solution was cooled to 5° C. and kept at 5° C. for 16 hours for lowering the solubility of water to the sodium sulfate, thereby precipitating the sodium sulfate crystal (containing crystal water). The sodium sulfate crystal was then collected and dried at a high temperature of 120° C. for 3 hours to remove the crystal water in the sodium sulfate crystal. The dried sodium sulfate crystal had a purity of 89% and a heavy metal content of 23 ppm. The heavy metals mainly came from the crystal water. The above process took about 24 hours. Compared to Example 2, this process took more time to obtain the sodium sulfate with a lower purity and a higher heavy metal content.

### Comparative Example 4

420 g of water and 1000 g of the fly ash B were mixed to generate a liquid dissolving the impurities of the fly ash B and an un-dissolved solid (about 837 g). After removing the liquid, the solid was dissolved with 1250 g of water at 50° C. to obtain a first solution. The pH value of the first solution was adjusted to 10. Heavy metal capture agents such as 38 g of ionic type polyacrylamide (commercially available from ACROS) and 12 g of iron sulfate were added to the first solution to generate a precipitate. The precipitate included the heavy metal capture agent and the heavy metals (from the fly ash B) captured by the heavy metal capture agent. The precipitate was then removed by filtering to obtain a second solution. The above steps were similar to those in Example 2.

Subsequently, the second solution was heated to 90° C. and vacuumed to remove water for precipitating sodium sulfate crystal (containing crystal water). The second solution was then cooled to 20° C. and kept at 20° C. for 2 to 3 hours to precipitate sodium sulfate crystal (containing crystal water). The sodium sulfate crystal was then collected and dried at a high temperature of 120° C. for 3 hours to remove the crystal water in the sodium sulfate crystal. The dried sodium sulfate crystal had a purity of 87% and a heavy metal content of 32 ppm. The heavy metals mainly came from the crystal water. The above process took about 16 hours. Compared to Example 2, this process took more time to obtain the sodium sulfate with a lower purity and a higher heavy metal content.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A method of collecting anhydrous sodium sulfate from fly ash, comprising:
(i) evenly mixing water and fly ash, and removing liquid and keeping a solid;
(ii) dissolving the solid with water at 40° C. to 70° C. to obtain a first solution, and adjusting pH value of the first solution to 9 to 11;
(iii) adding a heavy metal capture agent to the first solution to form a precipitate, and removing the precipitate to obtain a second solution;
(iv) heating the second solution to 60° C. to 80° C., and adding a precipitation promoter to the second solution to precipitate anhydrous sodium sulfate crystal;
(v) cooling the second solution and the anhydrous sodium sulfate crystal to 35° C. to 55° C. for precipitating more anhydrous sodium sulfate crystal; and
(vi) collecting and drying the anhydrous sodium sulfate crystal.

2. The method as claimed in claim 1, wherein the water and the fly ash in step (i) have a weight ratio of 20:80 to 50:50.

3. The method as claimed in claim 1, wherein the water and the solid in step (ii) have a weight ratio of 50:50 to 80:20.

4. The method as claimed in claim 1, wherein the heavy metal capture agent in step (iii) comprises ionic type polyacrylamide and iron sulfate.

5. The method as claimed in claim 1, wherein the temperature of heating the second solution in step (iv) is higher than the temperature of water in step (ii).

6. The method as claimed in claim 1, wherein the precipitation promoter in step (iv) comprises water soluble carbonate, sulfate, nitrate, or a combination thereof.

7. The method as claimed in claim 1, wherein the anhydrous sodium sulfate crystal collected in step (vi) and the precipitation promoter used in step (iv) have a weight ratio of 100:5 to 100:15.

8. The method as claimed in claim 1, wherein the fly ash in step (i) has a heavy metal content of >1000 ppm, and the anhydrous sodium sulfate crystal collected in step (vi) has a heavy metal content of less than 20 ppm.
